(19) United States
(12) Patent Application Publication
(10) Pub. No.: US 2021/0402697 A1
(43) Pub. Date: Dec. 30, 2021

(54) COMPUTATIONS OF VALUES FOR BUILD MATERIAL RECYCLABILITY RATIO SELECTIONS

(71) Applicant: HEWLETT-PACKARD DEVELOPMENT COMPANY, L.P., Spring, TX (US)

(72) Inventors: Erica Fung, San Diego, CA (US); Jesiska Tandy, San Diego, CA (US); Yi Feng, San Diego, CA (US); Alay Yemane, San Diego, CA (US); Allen Jin, San Diego, CA (US)

(21) Appl. No.: 16/605,224

(22) PCT Filed: Apr. 30, 2018
(86) PCT No.: PCT/US2018/030093

§ 371 Date: Oct. 15, 2019

(51) Int. Cl. B29C 64/357; B29C 64/153; B29C 64/393; B33Y 10/00; B33Y 50/02

(52) U.S. Cl. CPC B29C 64/357; B29C 64/153; B33Y 50/02; B33Y 10/00; B29C 64/393

(57) ABSTRACT

In some examples, a method measures values of a property of a build material aged in a heated environment, and computes, using a predictive model for each of a plurality of recyclability ratios, output values of the property over a plurality of generations of the build material, each recyclability ratio of the plurality of recyclability ratios representing relative amounts of fresh build material and used build material. The method further includes presenting the output values of the property over the plurality of generations to enable selection of a recyclability ratio to use in building a part using the build material.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on a 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIG. 1 is a block diagram of an arrangement including an experimental system, a recyclability ratio selection system, and a build system, in accordance with some examples.

FIG. 2 is a graph showing curves of predicted viscosities of a build material as a function of generation, based on output of a build material property predicting model, according to some examples.

FIG. 3 shows a table depicting different fractions of build material processed by different numbers of build cycles, according to some examples.

FIG. 4 is a flow diagram of a process according to some examples.

FIG. 5 is a block diagram of a storage medium storing machine-readable instructions according further examples.

FIG. 6 is a block diagram of a system according to additional examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the ensuing discussion, use of the terms “above,” “below”, “upper,” and “lower” are to allow for ease of explanation when describing elements in the views shown in various figures. Note that depending on the actual orientation of a device or apparatus, the foregoing terms can refer to other relative arrangements other than being higher or lower along a vertical orientation. Such terms can refer to a diagonal relationship, or to an upside-down relationship (where the terms “above,” “below,” “upper,” and “lower” would be reversed from their ordinary meanings).

In a three-dimensional (3D) printing system, a build material can be used to form a 3D object, by depositing the build material(s) as successive layers on a build platform until the final 3D object is formed. Portions of each layer can be solidified (e.g., fused) to form each layer of the object being printed. In some examples, a build material can include a powdered build material that is composed of particles in the form of fine powder or granules. In other examples, other forms of build materials can be used, such as fiber-based build materials and so forth. The powdered build material can include, for example, metal particles, plastic particles, polymer particles, ceramic particles, or particles of other materials.

Agents can be dispensed (such as through a printhead or other liquid delivery mechanism) to a layer of build material for processing the layer of build material. Examples of agents include a fusing agent that absorbs the energy emitted from an energy source to melt a powder, and a detailing agent to achieve a target surface quality and accuracy in forming a part. A detailing agent can also be used for cooling. In further examples, agents can also include a binder agent, such as used in a chemical binder 3D printing system. The binder agent is used to bind or join build material particles. Other types of agents can be used, such as those for binding metal particles in a metal-type 3D printing system.

According to an example, a fusing agent may be an ink-type formulation comprising carbon black. In an example, a fusing agent may additionally include a light absorber, e.g., an infrared light absorber, a near infrared light absorber, a visible light absorber, or an ultraviolet light absorber. A fusing agent can also include visible light enhancers, such as dye based colored ink and pigment based colored ink. According to an example, a detailing agent may be a formulation commercially known as V1Q61A “HP detailing agent” available from HP Inc. According to one example, a suitable build material may be PA12 build material commercially known as V1R10A “HP PA12” available from HP Inc.

For example, in a 3D printing cycle, after a layer of powder is deposited onto a build platform (or onto a partially formed 3D object) in the 3D printing system, a fusing agent with a target shape can deposited on the layer of powder. In addition, a detailing agent can be strategically deposited on portions of the layer of powder. Following the application of the fusing and detailing agents, an energy source (e.g., a heating lamp or multiple heating lamps) is activated to melt the powder on which fusing agent has been applied, to form the corresponding layer of the 3D object. Next, a new layer of powder is deposited on top of the 3D part that has been formed so far, and the process is re-iterated in the next 3D printing cycle.

During such a 3D printing process, powders may be exposed to high temperatures (e.g., over 100° C.) over relatively long periods of time. Any unfused powder (not fused by applied heat transferred to the powder by a fusing agent) during the printing process can experience two competing reactions: (1) a continuous solid state polymerization that increases the molecular weight of the powder material, and (2) a thermal degradation that reduces the molecular weight of the powder material.

In a 3D printing system, on average, some percentage of deposited powder is fused into a 3D part. The remaining percentage of the deposited powder remains unfused, and can be reused for the next printing cycle to avoid waste and reduce printing costs. Generally, X % of a deposited powder is fused, while Y % (where Y=100−X) of the deposited powder is unfused.

Due to the above-noted reactions resulting from exposure, or repeated exposure, to high heat during printing, the unfused powder (hereinafter referred to as “used powder”) may not be completely recyclable. Used powder can experience an increase in viscosity that causes mechanical properties of the powder to change in a way that may lead, for example, to poor processability of the powder during printing and an increase in surface defects of a formed 3D part.

To address the foregoing, fresh, unused powder may be added to the used powder. The amount of fresh powder added to the used powder can depend on various factors. The optimal ratio of fresh powder to used powder to achieve consistent formation of a 3D object can be manually determined by a materials designer using an experimental process. However, this experimental process is time consuming and tedious.

Powder used in 3D printing can be recycled through multiple generations. In an initial generation (generation 0), the powder used in a 3D printing cycle is 100% fresh powder. In the next generation (generation 1), used powder from generation 0 is mixed with fresh powder. In the subsequent generation (generation 2), used powder from generation 1 (as well as generation 0) is mixed with fresh powder. The foregoing continues for some number of generations until the 3D printing is complete.

The manual experimental process to determine an optimal ratio of fresh powder and used powder for each printing cycle can involve the performance of multiple experimental iterations for a target number of generations. Such a process can take a long period of time (especially for a large number of generations) and can involve the use of a large amount of powder.

In accordance with some implementations of the present disclosure, an automated system is provided to allow for the prediction of a property (or multiple properties) of a build material (that includes a powder) over multiple generations. The automated system uses a predictive model that receives input data and outputs a predicted property (e.g., viscosity or melt flow index of the build material) over multiple generations of the build material. Using the output values of the predicted property from the predictive model, a recyclability ratio of fresh build material to used build material can be set for optimal (or enhanced) 3D printing performance.

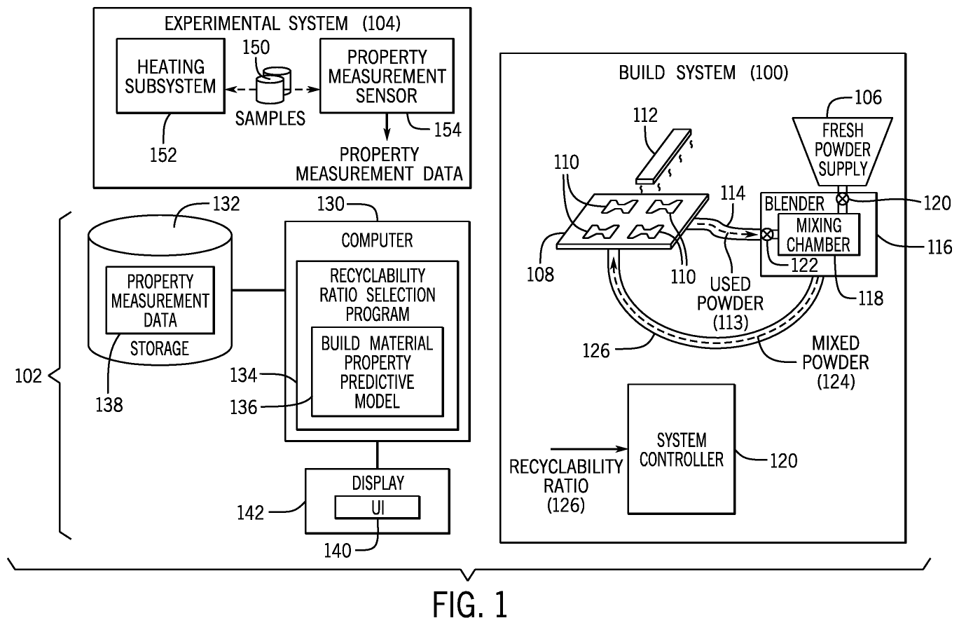

FIG. 1 is a block diagram of an example arrangement that includes a build system 100 that is used to build 3D objects using a build material (or multiple build materials), a recyclability ratio selection system 102, and an experimental system 104.

In some examples, the build system 100 can include a 3D printing system. In other examples, other types of build systems for forming 3D objects can be used.

The build system 100 includes a fresh powder supply 106 that includes a fresh build material in powder form (which has not previously been used in a build process, such as a 3D printing process). The build system 100 also includes a build platform 108 on which solidified parts 110 can be formed. A solidified part 110 is formed based on fusing a portion of a layer of build material powder provided to the build platform 108. The fusing of the portion of the layer of build material powder is accomplished by applying a fusing agent to the portion, and then exposing the solidified part 110 to heat produced by a heater 112.

Any unfused powder is transported away from the build platform 108 as used powder 113 through a transport mechanism 114 (which can include a transport conduit and other elements to cause flow of the used powder 113) to a blender 116. Although not shown, the build system 100 can further include a sieve to filter the used powder 113 transported by the transport mechanism 114. The sieve has apertures of a given size (or multiple sizes) to prevent agglomerated build material particles or other contaminants of greater than a certain size(s) from passing through the sieve, such that such large particles are not supplied to the blender 116.

The blender 116 includes powder flow dispensers 120 and 122, such as valves or other mechanisms to control flow of build material powder. The powder flow dispenser 120 can be adjusted to a fully open position, a partially open position(s), and a closed position, to control fresh powder flow from the fresh powder supply 106 to a mixing chamber 118 within the blender 116.

The powder flow dispenser 122 can be adjusted to a fully open position, a partially open position(s), and a closed position, to control used powder flow from the transport mechanism 114.

By adjusting the powder flow dispensers 120 and 122, the relative amounts of fresh build material powder and used build material powder supplied into the mixing chamber 118 can be controlled.

The powder flow dispensers 120 and 122 can be controlled by a system controller 120 that is part of the build system 100. The system controller 124 controls the powder flow dispensers 120 and 122 based on a recyclability ratio 126 that is input into the system controller 124.

As used here, a “controller” can refer to a hardware processing circuit, such as any or some combination of the following: a microprocessor, a core of a multi-core microprocessor, a microcontroller, a programmable integrated circuit device, a programmable gate array, or any other hardware processing circuit. Alternatively, a “controller” can refer to a combination of a hardware processing circuit and machine-readable instructions (software and/or firmware) executable on the hardware processing circuit.

The recyclability ratio 126 represents a ratio between an amount of fresh build material and an amount of used build material. In some examples, the recyclability ratio 126 is the ratio of the amount of fresh build material to the amount of used build material. In other examples, the recyclability ratio 126 can be expressed differently, such as a ratio of the amount of used build material to the amount of fresh build material.

Assuming that the recyclability ratio 126 is 0.2, for example, then the system controller 120 can control the powder flow dispensers 120 and 122 to control the respective rates of flow of the fresh build material powder and the used build material such that 20% of the build material flowing into the mixing chamber 118 is fresh build material powder, and 80% of the build material flowing into the mixing chamber 118 is used build material powder.

Mixed build material powder 124 (which includes a mixture of used powder from a previous generation and fresh powder from the fresh powder supply 106) is output by the blender 116 and delivered through a transport mechanism 126 to the build platform 108 for use in a next build cycle of a next layer of the parts 110.

In accordance with some implementations of the present disclosure, the recyclability ratio 126 can be input to the system controller 124 based on an output of the recyclability ratio selection system 102. In some examples, the recyclability ratio selection system 102 includes a computer 130 (or multiple computers) and a storage 132 (which can be implemented using a storage device or multiple storage devices).

The computer 130 executes a recyclability ratio selection program 134, which includes machine-readable instructions. The recyclability ratio selection program 134 uses a build material property predictive model 136. Although the build material property predictive model 136 is depicted as being part of the recyclability ratio selection program 134, it is noted that in other examples, the build material property predictive model 136 can be separate from the recyclability ratio selection program 134.

The storage 132 stores property measurement data 138 that is produced by the experimental system 104. The experimental system 104 is used to perform experiments on build material samples 150. Each build material sample 150 can include a build material powder placed in a container (e.g., a vial). For example, the experimental system 104 can include a heating subsystem 152, which can include an oven, for example. The build material samples 150 can be provided into the heating subsystem 152 and subjected to heat for respective different time intervals.

Once a build material sample 150 has been aged in the heating subsystem 152 for a respective time interval, a property of the build material sample 150 can be measured by a property measurement sensor 154. Although just one property measurement sensor 154 is shown in FIG. 1, it is noted that in other examples, more than one property measurement sensor 154 can be used.

Although FIG. 1 shows the property measurement sensor 154 as being outside the heating subsystem 152, in other examples, as the samples 150 are heated by the heating subsystem 152, the property measurement sensor 154 can measure a property of the samples 150. An example of such a property measurement sensor 154 can be a rheometer.

In some examples, the property of each build material sample 150 that is measured by the property measurement sensor 154 is a viscosity of the build material sample 150. The powder of the build material sample 150 can have a relative solution viscosity (also referred to as “solution viscosity” for brevity). A measurement protocol for measuring the solution viscosity of the powder can be according to International Standard ISO 307, 5^{th} ed., May 15, 2007. In other examples, other techniques for determining the solution viscosity of the powder can be employed.

To measure the viscosity of a build material sample 150, the property measurement sensor 154 can include a capillary viscometer, such as a miniPV-HX viscometer from CANNON Instrument Company. The measured viscosity is based on the time that it takes for a certain volume of fluid (solvent or solution without the build material) to pass through the capillary viscometer under the weight of the fluid or gravity compared to the same fluid (solvent or solution) admixed with a small amount of the build material. The higher the viscosity, the longer it takes for the fluid to pass through the capillary viscometer. Thus, a relative solution viscosity is defined as a ratio that compares the time for a fluid with the build material to pass through the capillary viscometer compared to the time it takes for the fluid alone to pass through the capillary viscometer. The fluid with the build material is more viscous than the pure fluids, so that the ratio is a number greater than 1.

In other examples, the property measurement sensor 154 can measure a melt flow index (MFI) of the build material sample 150. Techniques for determining the MFI of a powder are described in the American Section of the International Association for Testing Materials ATSM D1238. The MFI is a measure of the ease of flow of the melt of the build material.

The solution viscosity or MFI is a proxy for a molecular weight of the build material sample 150. Stated differently, the solution viscosity or MFI provides a representation of the molecule weight of the build material sample 150.

An experimental process of the experimental system 104 includes activating the heating subsystem 152 to set a temperature for heating the build material samples 150. In some examples, the temperature at which the build material samples 150 are exposed is a temperature between the melting point of the build material sample 150 and the crystallization temperature of the build material sample 150.

The build material samples 150 are placed in the heating subsystem 152 (e.g., an oven) for respective specified time intervals. Once aged, the property measurement sensor 154 acquires the property measurement for each of the build material samples 150. For example, the property measurement data output by the property measurement sensor 154 can include viscosities or MFIs of the respective build material samples 150 that have been aged for different respective time intervals.

The property measurement data output by the property measurement sensor 154 can be stored as 138 in the storage 132 of the recyclability ratio selection system 102. The property measurement data from the property measurement sensor 154 can be transmitted over a network for storing in the storage 132, or alternatively, the property measurement data from the property measurement sensor 154 can be downloaded to a removable storage medium that can then be connected to the computer 130 for storing in the storage 132.

The recyclability ratio selection program 134 inputs the property measurement data 138 (which can include solution viscosities or MFIs of build material samples aged in a heated environment for different times) into the build material property predictive model 136. For each of multiple recyclability ratios, the build material property predictive model 136 computes predicted values of a property of the build material (e.g., a viscosity, a MFI, etc.) over multiple generations of the build material.

The predicted values of the property computed by the build material property predictive model 136 can be presented in a user interface (UI) 140 that is displayed in a display device 142 coupled to the computer 130, either directly or over a network. The predicted values of the property as computed by the build material property predictive model 136 can be presented in the UI 140 to enable selection of the recyclability ratio (e.g., 126) to use by the build system 100.

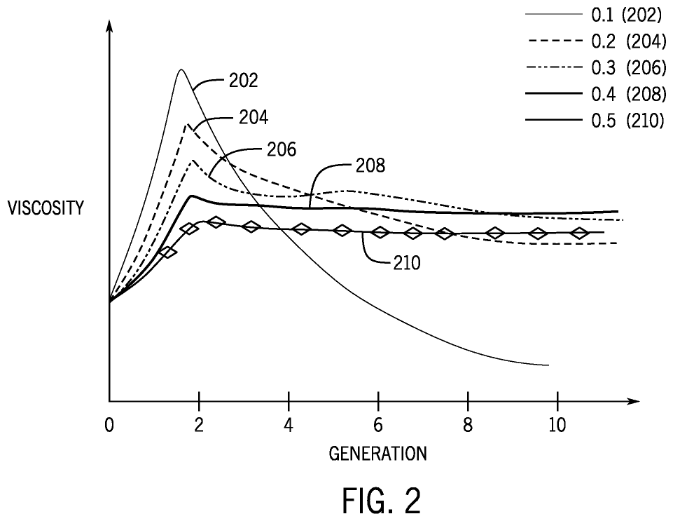

FIG. 2 is an example graph that plots viscosity (vertical axis) as a function of generation (horizontal axis). In other examples, other forms of outputs can be used to represent predicted viscosities output by the build material property predictive model 136.

The graph of FIG. 2 can be displayed in the UI 140 of FIG. 1. Five curves 202, 204, 206, 208, and 210 corresponding to recyclability ratios of 0.1, 0.2, 0.3, 0.4, and 0.5 are shown in the graph of FIG. 2.

The curve 202 represents predicted viscosities (as computed by the build material property predictive model 136) of a build material powder as a function of generation, assuming that the recyclability ratio used in a build system (e.g., 100 in FIG. 1) is 0.1 (i.e., the blender 116 mixes 10% fresh build material powder with 90% used build material powder). Similarly, the curve 204 represents predicted viscosities (as computed by the build material property predictive model 136) of a build material powder as a function of generation, assuming that the recyclability ratio used in a build system is 0.2. The curves 206, 208, and 210 similar represent other predicted viscosities for other recyclability ratios.

As a build material is aged with use in successive generations, the viscosities of the build material changes. At generation 0 (where the build material includes just fresh build material powder), the curves 202, 204, 206, 208, and 210 all start at the same viscosity. However, with different recyclability ratios, aging of the build material in successive generations causes viscosities to change differently.

More generally, the curves 202, 204, 206, 208, and 210 are examples of outputs that depict respective sets of viscosities for corresponding different recyclability ratios.

The selection of the recyclability ratio 126 to use in the build system 100 can be performed manually by a human analyst based on the output (e.g., the graph of FIG. 2) in the UI 140. Based on experience, the analyst can determine that a recyclability ratio of 0.2 (corresponding to the curve 204 in FIG. 2) achieves viscosity within a target range while avoiding the use of too much fresh powder in each new build cycle (that would occur if a higher recyclability ratio is used). The curve 202 indicates that the recyclability ratio of 0.1 can produce a viscosity that is too high (i.e., outside the target range) at some point.

In other examples, instead of using a human analyst, the predicted property values output by the build material property predictive model 136 can be analyzed by the recyclability ratio selection program 134 in an automated manner to select a recyclability ratio that achieves an objective (e.g., cost versus performance).

The following describes further details regarding how the build material property predictive model 136 is able to compute viscosities as a function of generation.

The UI 140 can also include input fields to allow entry of input information, such as a type of build system (e.g., type of 3D printing system), and a mode of operation (e.g., a print mode). Different types of build systems can have different operational characteristics. Different build material property predictive models 136 can be used for different types of build systems, or alternatively, the build material property predictive model 136 can predict property values in different manners for different types of build systems.

A print mode refers to how a part is printed (balanced, fast, mechanical, etc.). Different print modes can use different cycle times. Different build material property predictive models 136 can be used for different print modes, or alternatively, the build material property predictive model 136 can predict property values in different manners for different print modes.

The UI 140 can also include an input element (e.g., a field, a menu, etc.) in which a user can enter a number of generations for which the build material property predictive model 136 is to predict values of the property (e.g., viscosity or MFI).

As another example, the UI 140 can include an input element to receive the recyclability ratios for which the build material property predictive models 136 computes the output values of the property.

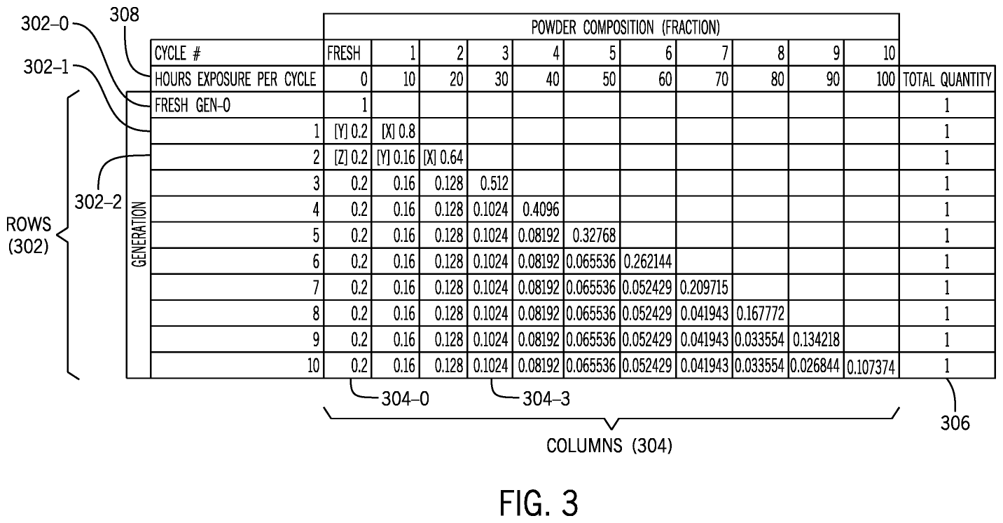

FIG. 3 shows a table with rows 302 that represent generations 0 through 10, and columns 304 that represent build cycles 0 through 10. A build cycle refers to a cycle of the build system 100 in which a layer (or multiple layers) of a part (or parts) is (are) formed. The build system 100 can perform multiple build cycles to complete the formation of respective 3D objects.

In build cycle 0 (represented by column 304-0), only fresh build material powder is used (since there was no previous build cycle). Generation 0 (row 302-0) includes only fresh build material powder. Generation 1 (row 302-1) includes newly added fresh build material powder and a build material powder that has gone through one build cycle. Generation 2 (row 302-2) includes newly added fresh build material powder, a build material powder that has gone through one build cycle, and a build material powder that has gone through two build cycles. More generally, generation N includes newly added fresh build material powder, a build material powder that has gone through one build cycle, . . . , and a build material powder that has gone through N build cycles.

It is assumed that the amount of fresh build material powder added to each generation is constant, i.e., it is based on the selected recyclability ratio. For example, for a recyclability ratio of 0.2, the amount of fresh build material powder added to each generation is 20%.

The table of FIG. 3 shows that generation 1 (row 302-1) has 80% used powder (Powder X) that has gone through one build cycle of heating (cycle 1 in the table), and 20% new, fresh powder (Powder Y) that has been added based on the recyclability ratio. In other words, the powder of generation 1 includes 80% Powder X and 20% Powder Y.

The powder of generation 1 then undergoes a build cycle of heating (cycle 2 in the table), which subjects Powder Y to one build cycle of heating, and Powder X to another build cycle of heating (for a total of two build cycles of heating). Generation 2 (row 302-2) has 80% of the powder of generation 1 that has undergone a build cycle of heating (cycle 2 in the table), and 20% of fresh build material powder (Powder Z) that has been added according to the recyclability ratio. Thus, the powder of generation 2 includes 20% Powder Z and 80% powder of generation 1 (including 80% Powder X and 20% Powder Y), which effectively includes 20% Powder Z (fresh powder), 64% Powder X (powder that has gone through two build cycles), and 16% Powder Y (powder that has gone through one build cycle).

This continues on up until generation N, where N is some specified value (e.g., input in the UI 140 of FIG. 1). N can be selected as the generation at which stabilization occurs, in some examples. However, N can have other values in other examples. Generally, the powder of generation N includes 20% fresh build material powder and 80% powder of generation N−1.

In the table of FIG. 3, within each of the rows 302, the fractional values of the powders from different build cycles add up to 1, as indicated by the Total Quantity column 306.

In the table of FIG. 3, a row 308 indicates the total exposure time of the fractional amount of build material powder in the corresponding cycle. For example, column 304-3 indicates that a build material powder that has been exposed to three build cycles has a total exposure time of 30 hours (assuming 10 hours per build cycle).

Various techniques can be used by the build material property predictive model 136 to estimate viscosities or MFIs. For example, the build material property predictive model 136 can apply a processing (e.g., interpolation or extrapolation or a formula such as a power law equation or cross equation) on the property measurement data 138 measured by the experimental system 104 (FIG. 1).

As noted above, the property measurement data 138 can include viscosities for multiple aged build material samples 150 at respective different time intervals (e.g., 20 hours, 30 hours, 48 hours, 72 hours, 90 hours, etc.). To estimate a viscosity at time points for which measurement data does not exist, the build material property predictive model 136 can apply interpolation (to estimate a viscosity at a time point between time points for which measurement data exists) or extrapolation (to estimate a viscosity at a time point that is beyond the largest or smallest time point for which measurement data exists).

The interpolation or extrapolation can be based on a linear fit, a power fit, an exponential fit, or any other fit of the measured viscosities. Once an equation based on the linear or power fit is derived, then a time point associated with a specific cycle (in the table of FIG. 3) can be input into the equation to derive the viscosity corresponding to the specific cycle.

In some examples, a viscosity table similar to the table of FIG. 3 can be built, except that the table is filled with viscosity values for the different cycles.

The values in the cells of the table of FIG. 3 (containing fractions of a build material powder of each cycle) can be multiplied with the corresponding viscosities in the viscosity table (which is effectively a matrix multiplication) to output viscosity values for each respective generation.

A similar technique can be applied for MFI values.

Another technique that can be used by the build material property predictive model 136 to estimate viscosities or MFIs is based on melt rheology.

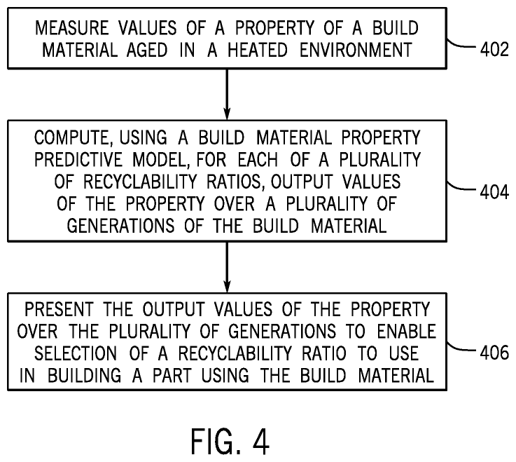

FIG. 4 is a flow diagram of a process according to some examples. The process can be performed using the arrangement of FIG. 1, for example.

The experimental system 104 can measure (at 402) values of a property (e.g., viscosity or MFI) of a build material aged in a heated environment. The recyclability ratio selection program 134 computes (at 404), using the build material property predictive model 136, for each of a plurality of recyclability ratios, output values of the property over a plurality of generations of the build material.

The recyclability ratio selection program 134 presents (at 406) the output values of the property over the plurality of generations (such as in the UI 140 of FIG. 1 and in the graph form as shown in FIG. 2) to enable selection of a recyclability ratio to use in building a part using the build material.

In alternative examples, instead of presenting the output values of the property over the plurality of generations computed by the build material property predictive model 136, the recyclability ratio selection program 134 can instead process the output values of the property in an automated manner to select the recyclability ratio.

The build system 100 can build a part using the build material in a plurality of build cycles, where fresh build material is added according to the selected recyclability ratio in a build cycle of the plurality of build cycles.

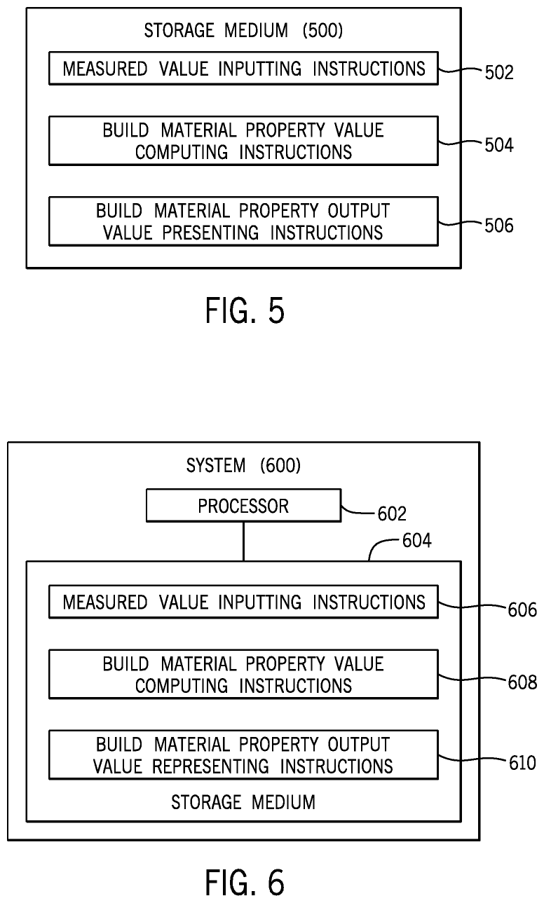

FIG. 5 is a block diagram of a non-transitory machine-readable or computer-readable storage medium 500 storing machine-readable instructions that upon execution cause a system to perform various tasks.

The machine-readable instructions include measured value inputting instructions 502 to input, into a predictive model (build material property predictive model 136), measured values of a property of a build material aged in a heated environment.

The machine-readable instructions include build material property value computing instructions 504 to compute, using the predictive model for each of a plurality of recyclability ratios, output values of the property over a plurality of generations of the build material.

The machine-readable instructions further include build material property output value presenting instructions 506 to present the output values of the property over the plurality of generations to enable selection of a recyclability ratio to use in building a part using the build material.

FIG. 6 is a block diagram of a system 600 including a processor 602 (or multiple processors), and a storage medium 604 storing machine-readable instructions executable on the processor 602 to perform various tasks. A processor can include a microprocessor, a core of a multi-core microprocessor, a microcontroller, a programmable integrated circuit, a programmable gate array, or another hardware processing circuit. Machine-readable instructions executable on a processor can refer to the instructions executable on a single processor or the instructions executable on multiple processors.

The machine-readable instructions include measured value inputting instructions 606 to input, into a predictive model, measured values of a property of a build material aged in an experimental heated environment, the property representing a molecular weight of the build material.

The machine-readable instructions further include build material property value computing instructions 608 to compute, using the predictive model for each of a plurality of recyclability ratios, output values of the property over a plurality of generations of the build material.

The machine-readable instructions further include build material property output value presenting instructions 610 to present the output values of the property over the plurality of generations to enable selection of a recyclability ratio to use in three-dimensional printing using the build material.

The storage medium 500 (FIG. 5) or 604 (FIG. 6) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
measuring values of a property of a build material aged in a heated environment;
computing, by a system comprising a processor using a predictive model for each of a plurality of recyclability ratios, output values of the property over a plurality of generations of the build material, each recyclability ratio of the plurality of recyclability ratios representing relative amounts of fresh build material and used build material; and
presenting, by the system, the output values of the property over the plurality of generations to enable selection of a recyclability ratio to use in building a part using the build material.

2. The method of claim 1, further comprising:
build the part using the build material in a plurality of build cycles, wherein fresh build material is added according to the recyclability ratio in a build cycle of the plurality of build cycles.

3. The method of claim 1, wherein the property comprises a viscosity of the build material.

4. The method of claim 1, wherein the property comprises a melt flow index of the build material.

5. The method of claim 1, wherein the measured values of the property are of a plurality of build material samples in the heated environment measured by a measurement sensor after aging by respective different time intervals.

6. The method of claim 1, further comprising:
presenting, in a user interface, an input element to accept an input of a number of generations,
wherein the plurality of generations over which the output values of the property are computed by the predictive model comprises the number of generations received according to the input element in the user interface.

7. The method of claim 6, wherein presenting the output values of the property over the plurality of generations comprises presenting the output values in the user interface.

8. The method of claim 6, further comprising:
presenting, in the user interface, an input element to receive the plurality of recyclability ratios for which the predictive model computes the output values of the property.

9. The method of claim 1, wherein the predictive model applies processing on the input measured values of the property of the build material to compute the output values of the property over the plurality of generations of the build material.

10. The method of claim 1, further comprising:
processing, by the system, the output values of the property over the plurality of generations to select the recyclability ratio.

11. A non-transitory machine-readable storage medium storing instructions that upon execution cause a system to:
input, into a predictive model, measured values of a property of a build material aged in a heated environment;
compute, using the predictive model for each of a plurality of recyclability ratios, output values of the property over a plurality of generations of the build material, each recyclability ratio of the plurality of recyclability ratios representing relative amounts of fresh build material and used build material; and
present the output values of the property over the plurality of generations to enable selection of a recyclability ratio to use in building a part using the build material, the presented output values of the property comprising a first set of output values of the property for a first recyclability ratio, and a second set of output values of the property for a second recyclability ratio.

12. The non-transitory machine-readable storage medium of claim 11, wherein the property comprises a viscosity of the build material or a melt flow index of the build material.

13. The non-transitory machine-readable storage medium of claim 11, wherein presenting the output values of the property over the plurality of generations comprises presenting a plurality of curves of the output values, each respective curve of the plurality of curves corresponding to a respective recyclability ratio of the plurality of recyclability ratios.

14. A system comprising:
a processor; and
a storage medium storing instructions executable on the processor to:
input, into a predictive model, measured values of a property of a build material aged in an experimental heated environment, the property representing a molecular weight of the build material;
compute, using the predictive model for each of a plurality of recyclability ratios, output values of the property over a plurality of generations of the build material, each recyclability ratio of the plurality of recyclability ratios representing relative amounts of fresh build material and used build material; and
present the output values of the property over the plurality of generations to enable selection of a recyclability ratio to use in three-dimensional printing using the build material.

15. The system of claim 14, wherein the measured values are collected by a measurement device in the experimental heated environment.
